(19) United States
(12) Patent Application Publication
(10) Pub. No.: US 2011/0087498 A1
(43) Pub. Date: Apr. 14, 2011

(54) Surgical system providing identification of billing codes

(76) Inventors: Pravin U. Dugel, Phoenix, AZ (US); Roger D. Thomas, Tustin, CA (US); John C. Huculak, Mission Viejo, CA (US)

(21) Appl. No.: 12/576,268

(22) Filed: Oct. 9, 2009

(51) Int. Cl. G06Q 50/00; G06K 7/10; G06F 3/041

(52) U.S. Cl. 705/2; 235/462.01; 345/173

(57) ABSTRACT

An apparatus and method of identifying and selecting a billing code for a surgical procedure using a surgical system.

### FIELD OF THE INVENTION

The present invention generally pertains to surgical systems. More particularly, but not by way of limitation, the present invention pertains to surgical systems used for ophthalmic surgery.

### DESCRIPTION OF THE RELATED ART

Various private insurers and government agencies provide reimbursement for certain surgical procedures or portions thereof. This reimbursement is based on billing codes that represent the surgical procedure performed. Currently, after an ophthalmic surgeon finishes a procedure on a patient, he or she will dictate a summary of the procedure, including any applicable billing codes, with a voice recorder. This dictation is typically transcribed by administrative personnel to a hard copy form containing the applicable billing codes identified by the surgeon, and this form is eventually submitted to the appropriate reimbursement entity (i.e. private insurer, government agency) for payment. Surgeons may make errors in the billing codes during dictation, administrative personnel may make errors in transcription, and the hard copy forms may be lost before they are sent to the appropriate reimbursement entity. All of these inadvertent errors result in overpayment or underpayment for the surgical treatment provided. In addition, applicable laws place the burden of providing correct billing codes to a reimbursement entity on the surgeon. Therefore, a need exists for more accurately and efficiently accomplishing this reimbursement process. The present invention is directed to a surgical system that addresses this need.

### SUMMARY OF THE INVENTION

In a preferred embodiment, the present invention comprises a method of identifying and selecting a billing code for a surgical procedure. A surgical system is provided. The surgical system has a console, a computer disposed within the console, and a touch screen display operatively coupled to the computer. After a surgical procedure is performed using the surgical system, a list of actual steps performed during the surgical procedure as identified and recorded by the computer is displayed on the touch screen display, a list of all billing codes potentially applicable to the actual steps is displayed on the touch screen display, and one of the billing codes from the list of all billing codes is selected by pressing the selected one of the billing codes on the touch screen display.

### BRIEF DESCRIPTION OF THE DRAWINGS

For a more complete understanding of the present invention, and for further objects and advantages thereof, reference is made to the following description taken in conjunction with the accompanying drawings in which:

FIG. 1 is a schematic, perspective view of a surgical system according to a preferred embodiment of the present invention; and

FIG. 2 is a schematic of an “end case” screen of a graphic user interface of the surgical system of FIG. 1 according to a preferred embodiment of the present invention.

### DETAILED DESCRIPTION OF THE PREFERRED EMBODIMENTS

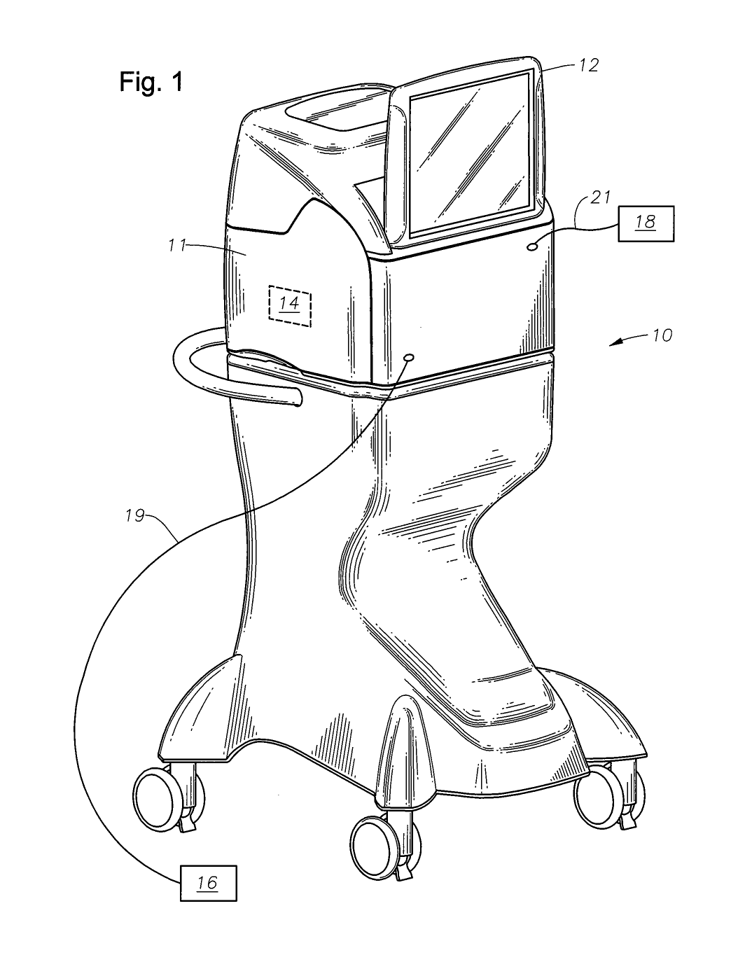

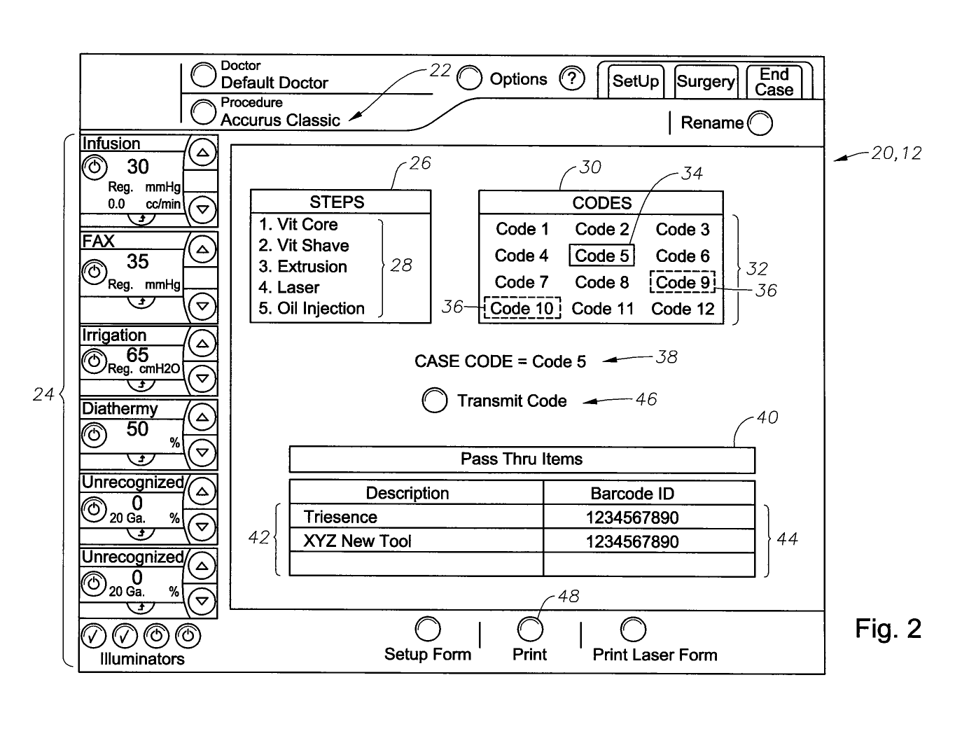

The preferred embodiments of the present invention and their advantages are best understood by referring to FIGS. 1-2 of the drawings, like numerals being used for like and corresponding parts of the various drawings.

FIG. 1 shows a surgical system 10 according to a preferred embodiment of the present invention. As shown in FIG. 1, surgical system 10 is an ophthalmic surgical system. System 10 preferably includes a console 11, a graphic user interface/touch screen display 12, a computer or microprocessor 14 disposed within console 11 for managing and recording the various functions performed during surgery, a foot controller 16, and a bar code scanner 18. Foot controller 16 is operatively coupled to system 10 via cable 19, and bar code scanner 18 is operatively coupled to system 10 via cable 21. Although not shown in FIG. 1, system 10 preferably also includes a surgical cassette and other consumables for managing the fluidics of the surgical procedure; a series of liquid, electrical, and pneumatic connectors or ports for operatively coupling with the various surgical handpieces associated with system 10; an illuminator module; and a laser module. Exemplary handpieces utilized in anterior segment ophthalmic surgery (i.e. cataract surgery) performed using system 10 include an ultrasonic handpiece, an irrigation/aspiration handpiece, and/or a diathermy handpiece. A preferred ultrasonic handpiece is a phacoemulsification handpiece. Exemplary handpieces utilized in posterior segment ophthalmic surgery (i.e. vitreoretinal surgery) performed using system 10 include a vitrectomy probe, an infusion cannula, an extrusion handpiece, surgical scissors, and/or a diathermy handpiece. A preferred surgical system 10 is the CONSTELLATION® surgical system available from Alcon Laboratories, Inc. of Fort Worth, Tex.

FIG. 2 shows an exemplary “end case” screen 20 displayed on graphic user interface 12 after the surgeon has performed a surgical procedure. End case screen 20 displays the procedure 22 that was just performed by the surgeon and the various machine settings 24 associated with the particular procedure 22. End case screen 20 has a first area 26 that lists the actual steps 28 performed during a particular procedure 22 that were automatically identified and recorded by computer 14. End case screen 20 also has a second area 30 that lists all the billing codes 32 that are potentially applicable to procedure 22 and/or steps 28. In addition, computer 14 preferably suggests the correct code from all the potentially applicable codes 32 for the actual surgical procedure 22 and/or steps 26 performed, and identifies this code via a unique color or other highlighting 34. Computer 14 may also suggest alternative codes 32 via different, unique color or highlighting 36. End case screen 20 preferably also has a third area 40 for listing “pass through” items 42 to be paid by the reimbursement entity. Pass through items 42 are preferably scanned via bar code scanner 18 as they are used during the surgical procedure, and the barcode ID 44 of each pass through item 42 appears in third area 40 of end case screen 20.

After reviewing all the information on end case screen 20, the surgeon or other user simply selects the correct billing code or codes 32 on touch screen 12, and the selected code(s) appears under the “case code” area 38 of end case screen 20, as shown by Code 5 in FIG. 2. The surgeon or other user then preferably presses a “transmit code” button 46 on touch screen 12, and the selected billing code(s) 32, as well as the appropriate surgical procedure, patient, surgeon, and pass through item 42 information, is electronically transferred to the appropriate reimbursement entity (and/or the surgeon's internal billing department) via the internet or other conventional wireless communication device. Alternatively, the surgeon or other user can press the “print” button 48 on touch screen 12 to create a hard copy of the selected billing code(s) 32, as well as the appropriate surgical procedure, patient, surgeon, and pass through item 42 information, for later transmittal to the appropriate reimbursement entity.

From the above, it may be appreciated that the present invention provides more accurate and efficient apparatus and methods of accomplishing the reimbursement process associated with a surgical procedure. It is believed that the operation and construction of the present invention will be apparent from the foregoing description. While the apparatus and methods shown or described above have been characterized as being preferred, various changes and modifications may be made therein without departing from the spirit and scope of the invention as defined in the following claims.

What is claimed is:

1. A surgical system, comprising:
a console;
a computer disposed within said console; and
a touch-screen display disposed on said console and operatively coupled to said computer;
wherein after a surgical procedure is performed using said surgical system, said computer displays:
a list of actual steps performed during said surgical procedure as identified and recorded by said computer in a first area of said touch screen display;
a list of all billing codes potentially applicable to said actual steps in a second area of said touch screen display; and
one of said billing codes from said list of all billing codes actually selected by a user by pressing said selected one of said billing codes on said touch screen display.

2. The surgical system of claim 1 wherein said computer highlights a suggested one of said billing codes from said list of all billing codes on said touch screen display.

3. The surgical system of claim 2 wherein said computer highlights an alternative one of said billing codes from said list of all billing codes on said touch screen display.

4. The surgical system of claim 1 wherein said computer displays a suggested one of said billing codes from said list of all billing codes in a unique color on said touch screen display.

5. The surgical system of claim 4 wherein said computer displays an alternative one of said billing codes from said list of all billing codes in a unique color on said touch screen display.

6. The surgical system of claim 1 further comprising a bar code scanner operatively coupled to said computer, and wherein said computer displays a barcode ID for a pass through item scanned by said bar code scanner during said surgical procedure in a third area of said touch screen display.

7. The surgical system of claim 1 wherein said computer displays a transmit code button on said touch screen display that upon pressing electronically transmits said selected one of said billing codes to an appropriate reimbursement entity.

8. The surgical system of claim 1 wherein said computer displays a print button on said touch screen display that upon pressing creates a hard copy of said selected one of said billing codes.

9. The surgical system of claim 1 wherein said computer displays a second one of said billing codes from said list of all billing codes actually selected by a user by pressing said selected second one of said billing codes on said touch screen display.

10. A method of identifying and selecting the correct billing code for a surgical procedure comprising the steps of:
providing a surgical system having a console, a computer disposed within said console, and a touch screen display operatively coupled to said computer; and
after a surgical procedure is performed using said surgical system, displaying a list of actual steps performed during said surgical procedure as identified and recorded by said computer on said touch screen display, displaying a list of all billing codes potentially applicable to said actual steps on said touch screen display, and selecting one of said billing codes from said list of all billing codes by pressing said selected one of said billing codes on said touch screen display.

11. The method of claim 10 further comprising the step of electronically transmitting said selected one of said billing codes to an appropriate reimbursement entity.
